(19) United States
(12) Patent Application Publication
(10) Pub. No.: US 2016/0313173 A1
(43) Pub. Date: Oct. 27, 2016

(54) METHOD AND APPARATUS FOR LEVEL MEASUREMENTS OR OTHER MEASUREMENTS USING TIME OF FLIGHT CALCULATIONS AND ESTIMATES OF FALSE ECHOES

(71) Applicant: HONEYWELL INTERNATIONAL INC., MORRISTOWN, NJ (US)

(72) Inventor: Adam Krolak, Plochocin (PL)

(21) Appl. No.: 14/744,473

(22) Filed: Jun. 19, 2015

Related U.S. Application Data
(60) Provisional application No. 62/150,944, filed on Apr. 22, 2015.

(51) Int. Cl. G01F 25/00; G01F 23/284

(52) U.S. Cl. CPC G01F 25/0061; G01F 23/284

(57) ABSTRACT

A method includes obtaining first information defining one or more characteristics of (i) a tank configured to store material and/or (ii) one or more obstacles within the tank. The method also includes estimating one or more false echoes using the first information. The one or more false echoes represent one or more potential reflections of a signal off (i) one or more surfaces of the tank and/or (ii) one or more surfaces of the one or more obstacles. The method further includes providing second information identifying the one or more false echoes to a calculation algorithm configured to measure a characteristic of the material in the tank.

### CROSS-REFERENCE TO RELATED APPLICATION AND PRIORITY CLAIM

This application claims priority under 35 U.S.C. §119(e) to U.S. Provisional Patent Application No. 62/150,944 filed on Apr. 22, 2015. This provisional application is hereby incorporated by reference in its entirety.

### TECHNICAL FIELD

This disclosure relates generally to inventory management systems. More specifically, this disclosure relates to a method and apparatus for level measurements or other measurements using time of flight calculations and estimates of false echoes.

### BACKGROUND

Processing facilities and other facilities routinely include tanks for storing liquid materials and other materials. For example, storage tanks are routinely used in tank farm facilities and other storage facilities to store oil or other materials. As another example, oil tankers and other transport vessels routinely include numerous tanks storing oil or other materials. Reliable measurements of the level (or other characteristic) of material in a tank are often needed or desired to support various functions, such as custody transfers and industrial process control operations.

A level of material in a tank is often measured using a time of flight technique, such as by reflecting a light, radar, or ultrasound measuring signal off the material in the tank and measuring the round-trip time from transmission of the measuring signal to reception of the reflection. Unfortunately, in these techniques, portions of the measuring signal can reflect from surfaces other than the material in the tank, such as from a wall, roof, or bottom of the tank or from internal obstacles like ladders, healing coils, or agitators within the tank. These reflections create false echoes, which complicate the identification and tracking of the reflection of the measurement signal from the surface of the material in the tank.

The existence of false echoes often leads to unstable or false level measurements. As a result, a level calculation algorithm typically needs to select the true echo reflection (reflected from the surface of the material in the tank) and reject the false echo reflections (reflected from other surfaces in the tank). Specialized level calculation algorithms have been created, but their reliability still needs to be improved. Existing algorithms are typically based on information available to the algorithm after installation of a level gauge instrument, where the information often comes primarily from the first measurements recorded by the instrument. This approach can therefore require significant time and effort in both initial setup and fine tuning of the algorithm. Also, many level measuring instruments are powered through analog two-wire current loops, which can significantly limit the computational power available for use by the level calculation algorithms.

### SUMMARY

This disclosure provides a method and apparatus for level measurements or other measurements using time of flight calculations and estimates of false echoes.

In a first embodiment, a method includes obtaining first information defining one or more characteristics of (i) a tank configured to store material and/or (ii) one or more obstacles within the tank. The method also includes estimating one or more false echoes using the first information. The one or more false echoes represent one or more potential reflections of a signal off (i) one or more surfaces of the tank and/or (ii) one or more surfaces of the one or more obstacles. The method further includes providing second information identifying the one or more false echoes to a calculation algorithm configured to measure a characteristic of the material in the tank.

In a second embodiment, an apparatus includes at least one processing device configured to obtain first information defining one or more characteristics of (i) a tank configured to store material and/or (ii) one or more obstacles within the tank. The at least one processing device is also configured to estimate one or more false echoes using the first information. The one or more false echoes represent one or more potential reflections of a signal off (i) one or more surfaces of the tank and/or (ii) one or more surfaces of the one or more obstacles. The at least one processing device is further configured to provide second information identifying the one or more false echoes to a calculation algorithm configured to measure a characteristic of the material in the tank.

In a third embodiment, a non-transitory computer readable medium contains instructions that when executed cause at least one processing device to obtain first information defining one or more characteristics of (i) a tank configured to store material and/or (ii) one or more obstacles within the tank. The computer readable medium also contains instructions that when executed cause the at least one processing device to estimate one or more false echoes using the first information. The one or more false echoes represent one or more potential reflections of a signal off (i) one or more surfaces of the tank and/or (ii) one or more surfaces of the one or more obstacles. The computer readable medium further contains instructions that when executed cause the at least one processing device to provide second information identifying the one or more false echoes to a calculation algorithm configured to measure a characteristic of the material in the tank.

In a fourth embodiment, a method includes receiving information identifying one or more false echoes. The one or more false echoes represent one or more potential reflections of a signal off (i) a tank configured to store material and/or (ii) one or more obstacles within the tank. The method also includes transmitting a measurement signal towards the material in the tank and receiving a return signal containing a true echo of the measurement signal off the material in the tank and one or more actual false echoes. The method further includes identifying a characteristic of material in the tank using the true echo of the measurement signal by rejecting the one or more actual false echoes using the information identifying the one or more false echoes.

Other technical features may be readily apparent to one skilled in the art from the following figures, descriptions, and claims.

### BRIEF DESCRIPTION OF THE DRAWINGS

For a more complete understanding of this disclosure and its features, reference is now made to the following description, taken in conjunction with the accompanying drawings, in which:

FIG. 1 illustrates an example tank measurement system according to this disclosure;

FIG. 2 illustrates an example workflow for estimating false echoes for use during tank measurements according to this disclosure;

FIGS. 3 and 4 illustrate specific example implementations of the workflow for estimating false echoes for use during tank measurements according to this disclosure;

FIG. 5 illustrates an example method for estimating false echoes for use during tank measurements according to this disclosure;

FIG. 6 illustrates an example processing system for tank measurements according to this disclosure;

FIG. 7 illustrates a specific example of a tank sensor according to this disclosure;

FIGS. 8A through 8G illustrate a first example configuration interface allowing a user to provide information about a target application for a tank sensor according to this disclosure; and

FIG. 9 illustrates a second example configuration interface allowing a user to provide information about a target application for a tank sensor according to this disclosure.

### DETAILED DESCRIPTION

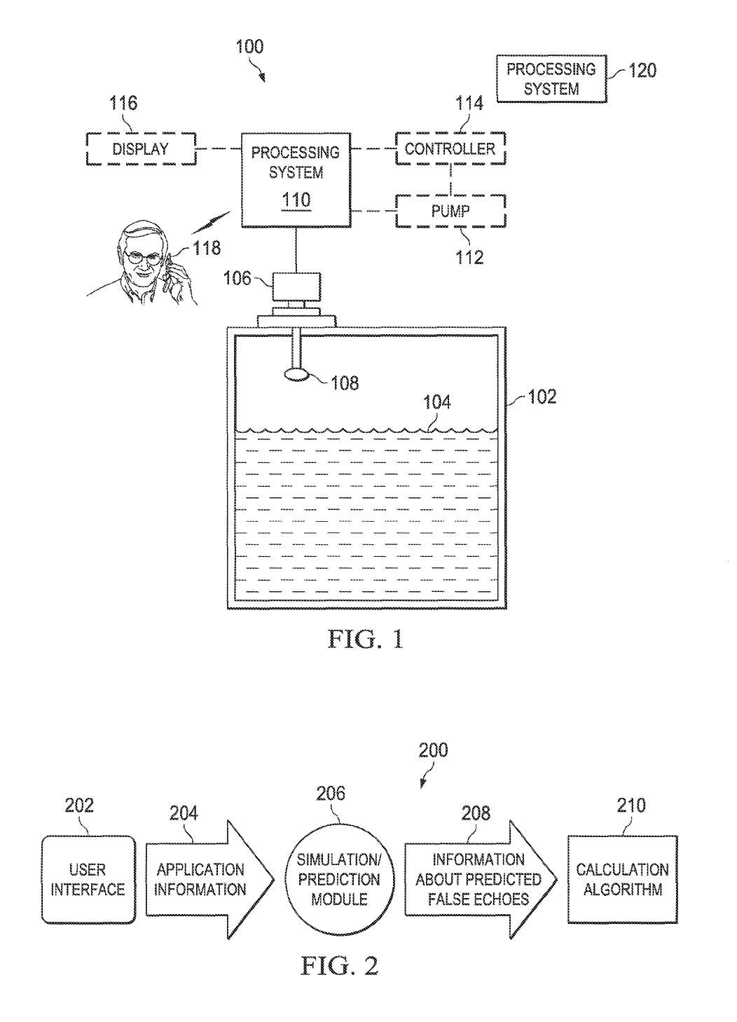

FIGS. 1 through 9, discussed below, and the various embodiments used to describe the principles of the present invention in this patent document are by way of illustration only and should not be construed in any way to limit the scope of the invention. Those skilled in the art will understand that the principles of the invention may be implemented in any type of suitably arranged device or system.

In the following description, the concepts disclosed in this patent document may be described as being used with a sensor for measuring the level of material in a tank. However, these concepts can be extended for use with other types of sensors, such as any type of sensor that transmits signals toward a material and that processes return signals (where rejection of false echoes may be useful). As particular examples, other types of sensors that could benefit from the rejection of false echoes include distance sensors (such as those measuring distance of material in a tank from a reference position) and volume or mass sensors (such as those determining volume or mass of material in a tank based on the height or level of material in the tank).

FIG. 1 illustrates an example tank measurement system 100 according to this disclosure. As shown in FIG. 1, the system 100 includes a tank 102 that can store one or more materials 104. The tank 102 generally represents any suitable structure for receiving and storing at least one liquid, solid, or other material. The tank 102 could, for example, represent an oil storage tank or a tank for storing other liquid(s) or other material(s). The tank 102 could also have any suitable shape and size. Further, the tank 102 could form part of a larger structure. The larger structure could represent any fixed or movable structure containing or associated with one or more tanks 102, such as a movable tanker vessel, railcar, or truck or a fixed tank farm.

A sensor 106 with at least one transceiver 108 is used in conjunction with a processing system 110 to measure the level or other characteristic(s) of material 104 in the tank 102. The transceiver 108 emits electromagnetic waves or other signals towards the material 104 and receives reflected signals from the material 104. The sensor 106 includes any suitable structure for generating signals for transmission and for receiving reflected signals. The transceiver 108 includes any suitable structure for transmitting and/or receiving signals, such as light, radar, or ultrasound signals. In some embodiments, the transceiver 108 could include at least one antenna or other structure for emitting and receiving wireless signals, such as a horn antenna. In other embodiments, the transceiver 108 could transmit and receive signals that propagate over at least one waveguide, such as a metal rod, coaxial cable, or metal wire probe that is inserted from top to bottom (or at least some portion) of the tank 102.

Data from the sensor 106 is provided to the processing system 110. The processing system 110 can use the data from the sensor 106 in any suitable manner. For example, the sensor 106 could provide data identifying the transmitted and reflected signals, and the processing system 110 can analyze the data to identify the distance of the material 104 in the tank 102 from the transceiver 108 or other reference location. From this, the processing system 110 could identify the level or other characteristic(s) of the material 104 in the tank 102. The processing system 110 could also use the determined characteristic(s) in any suitable manner. For instance, the processing system 110 could control automatic loading or unloading of the tank 102 by controlling a pump 112 or by providing the determined characteristic(s) to an external controller 114 that controls the pump 112. The processing system 110 could also notify personnel responsible for controlling the loading or unloading of the tank 102, such as by displaying the determined characteristic(s) on a local or remote display 116 or by transmitting the determined characteristic(s) to a wireless or other device 118. The processing system 110 could represent any suitable computing or processing system or device, such as a computing device, a process controller, or other system or device.

The sensor 106 or the processing system 110 can implement a calculation algorithm to identify the level or other characteristic(s) of material 104 in the tank 102. One operation typically performed by a calculation algorithm is the identification and tracking of a true echo reflection (the signal reflected from the surface of the material 104 in the tank 102) and the rejection of false echo reflections (signals reflected from other surfaces in the tank).

In accordance with this disclosure, the system 100 supports the use of a configuration interface and a simulation/prediction module. Among other things, the configuration interface allows a user to provide information about a target application for the sensor 106 before the sensor 106 is installed or during/after installation of the sensor 106. The information about the target application may include, among other information, the size/shape/composition of the tank 102, a mounting position of the sensor 106 on the tank 102, a mounting connection for the sensor 106 to the tank 102, and the position/size/composition of one or more obstacles in the tank 102. In some embodiments, the configuration interface may contain a graphical user interface designed to solicit at least some of this information from a user graphically. One example of a graphical user interface that could be used as the configuration interface to collect information is described in U.S. patent application Ser. No. 14/321,150 filed on Jul. 1, 2014 (which is hereby incorporated by reference in its entirety).

The simulation/prediction module uses the information about the target application to simulate or predict one or more characteristics (such as distances, amplitudes, or shapes) of false echoes in the tank 102. The characteristics of the false echoes could be expressed in any suitable manner, such as by using estimated positions or shapes in an envelope curve. A calculation algorithm executed by the sensor 106 or the processing system 110 can use the information about the predicted false echoes (provided by the simulation/prediction module) to reject false echoes of measurement signals during actual level measurements or other measurements.

In this way, additional and readily-available information (such as from an application and validation tool described in U.S. patent application Ser. No. 14/321,150 or from a user) can be used to predict and reject false echoes in time of flight calculations for tank measurements. This makes the measurements more reliable and supports calculation algorithms that require less time and effort from end users (such as less fine tuning and optimization). Moreover, this allows the processing power used by the sensor 106 or the processing system 110 to be reduced by moving some of the processing load to the configuration interface or by providing predictions of the false echo positions and sizes. It also supports faster and more reliable startup of a measurement instrument in a new application or installation.

Note that the simulation/prediction module could be part of the configuration interface, part of the calculation algorithm itself, or a separate module. If the simulation/prediction module is part of the configuration interface, the information about predicted false echoes could be provided to the sensor 106 or the processing system 110 in any suitable manner before, during, or after installation of the sensor 106 and the processing system 110. Making the simulation/prediction module part of the configuration interface could save a significant amount of power during execution of the calculation algorithm since the calculation algorithm need not simulate or predict the false echoes during each iteration of the calculation algorithm. However, other implementations according to this disclosure could include the false echo estimation (simulation/prediction) as part of the calculation algorithm.

Also note that the configuration interface (with or without the simulation/prediction module) and the simulation/prediction module (with or without the configuration interface) could each be executed, provided, or otherwise supported by any suitable device(s) in the system 100. For example, the configuration interface and the simulation/prediction module could be supported by the processing system 110 or by a separate processing system 120, which could be in communication with the processing system 110 or the sensor 106. When implemented on a separate processing system 120, the same tool(s) could be used to support configuration and false echo estimation for a number of sensors 106 or processing systems 110. In particular embodiments, the processing system 120 could support a web-based tool that allows users from any location with an Internet connection to provide information to the processing system 120, and the processing system 120 could then provide false echo information or other information to any suitable destination(s).

In addition, note that the estimation and prediction of false echoes needs to be done only one time, such as during startup for each application or installation. It need not be done continuously unless the tank or sensor information changes, such as when the tank shape or the position(s) of obstacle(s) changes. However, nothing prevents the estimation and prediction of false echoes from occurring at other times.

Although FIG. 1 illustrates one example of a tank measurement system 100, various changes may be made to FIG. 1. For example, the system 100 could include any number of tanks 102, sensors 106, processing systems 110, and other components. Also, the functional division shown in FIG. 1 is for illustration only. Various components in FIG. 1 could be omitted, combined, or further subdivided and additional components could be added according to particular needs. As a particular example, the processing system 110 could be integrated into (and form a part of) the sensor 106.

FIG. 2 illustrates an example workflow 200 for estimating false echoes for use during tank measurements according to this disclosure. As shown in

FIG. 2, the workflow 200 involves a user interface 202, which collects and outputs application information 204. The user interface 202 allows a user to enter details about a target application for the sensor 106. The user interface 202 represents any suitable interface for obtaining information from a user, such as a graphical user interface. In some embodiments, the user interface 202 can be implemented as described below. The application information 204 represents any suitable information related to a target application for a sensor from which false echoes can be estimated. Example application information 204 includes the size/shape/composition of a tank 102, a mounting position of a sensor 106 on the tank 102, a mounting connection of the sensor 106 to the tank 102, and the position/size/composition of one or more obstacles in the tank 102.

The application information 204 is provided to a simulation/prediction module 206, which uses the application information 204 to predict or estimate the false echoes that could appear in return signals when the sensor 106 is placed into operation. For example, the simulation/prediction module 206 could use the application information 204 to calculate the distances between the sensor 106 (or a portion thereof) and various tank or obstacle surfaces. Based on the calculated distances and the defined shapes/compositions of the surfaces, the simulation/prediction module 206 can calculate predicted positions, shapes, or other characteristics of false echoes in an envelope curve. The envelope curve represents the signals that may be received by a sensor 106 during sensing operations, where different positions within the curve denote different times of flight of a measurement signal. By identifying where false echoes are to be expected in the envelope curve, the sensor 106 or the processing system 110 could more easily identify the actual measurement signal's reflection (the true echo) from the surface of the material 104 in the tank 102 and more easily reject false echoes.

The simulation/prediction module 206 outputs false echo information 208, which is provided to a calculation algorithm 210. The false echo information 208 identifies one or more characteristics of the false echoes estimated by the simulation/prediction module 206. During operation of the sensor 106, the sensor 106 transmits measurement signals and receives reflected measurement signals as return signals. The return signals include various peaks associated with reflections of the measurement signals from the material 104 and from various tank and obstacle surfaces. The calculation algorithm 210 analyzes the return signals, identifies and tracks true echoes from the surface of the material 104, and uses the true echoes along with time of flight calculations to identify the level or other characteristic(s) of material 104 in the tank 102. The calculation algorithm 210 also rejects false echoes during the calculations, and this is supported using the estimated false echoes identified by the false echo information 208.

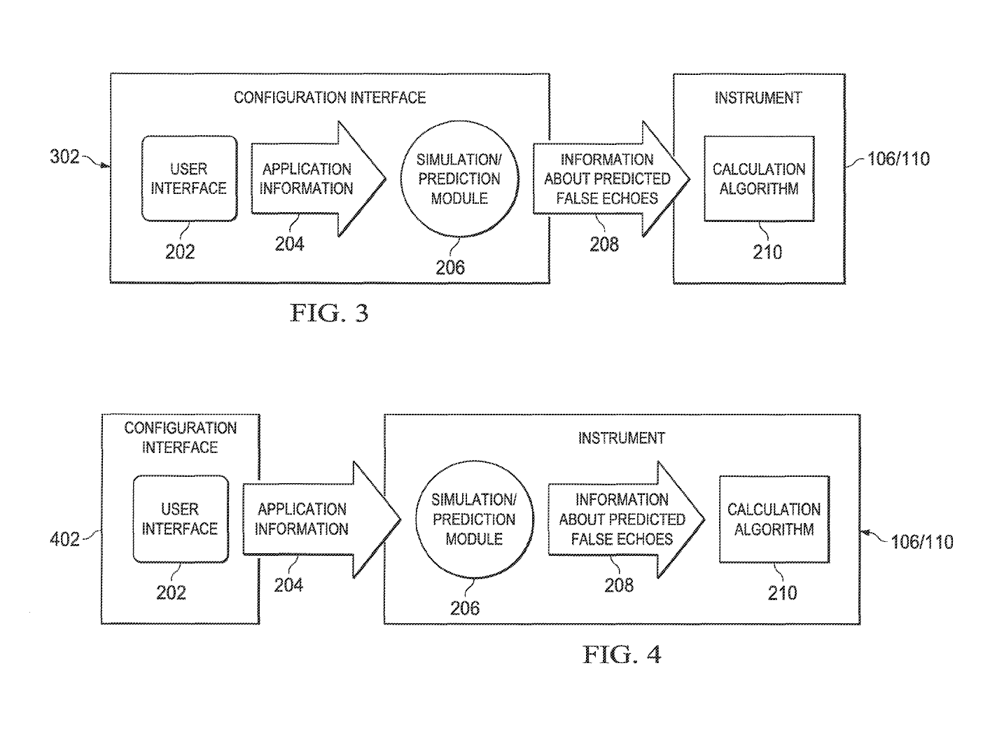

FIGS. 3 and 4 illustrate specific example implementations of the workflow 200 for estimating false echoes for use during tank measurements according to this disclosure. In FIG. 3, a configuration interface 302 implements the user interface 202 and the simulation/prediction module 206, while the sensor 106 or the processing system 110 implements the calculation algorithm 210. In some embodiments, the configuration interface 302 could denote a software application executed by the processing system 110, the processing system 120, or some other component. If the configuration interface 302 and the calculation algorithm 210 are implemented using different devices, the information 208 about predicted false echoes can be delivered to the calculation algorithm 210 in any suitable manner. Example mechanisms include providing the false echo information 208 via an industrial digital control system with digital communication (like HART, FF, or DE), a handheld programming device, or a memory storage device.

In FIG. 4, a configuration interface 402 implements the user interface 202, while the sensor 106 or the processing system 110 implements the simulation/prediction module 206 and the calculation algorithm 210. Again, in some embodiments, the configuration interface 402 could denote a software application executed by the processing system 110, the processing system 120, or some other component. If the configuration interface 402 and the simulation/prediction module 206 are implemented using different devices, the information 204 about the target application can be delivered to the simulation/prediction module 206 in any suitable manner. Example mechanisms include providing the application information 204 via an industrial digital control system with digital communication (like HART, FF, or DE), a handheld programming device, or a memory storage device. In particular embodiments, the simulation/prediction module 206 could actually be treated as an integral part of the calculation algorithm 210 and could be executed once or multiple times to identify the false echo information 208, although this need not be the case in other implementations.

Each component 202, 206, 210 in the workflow 200 could be implemented using any suitable hardware or combination of hardware and software/firmware instructions. For example, each component 202, 206, 210 could be implemented using software instructions executed by at least one processing device of a processing system (such as system 110 or 120). As a particular example, the simulation/prediction module 206 could be implemented as a logic module with calculation capabilities. In some embodiments, the simulation/prediction module 206 can be implemented using the MULTIPHYSICS software product suite from COMSOL INC. or equivalent.

Although FIG. 2 illustrates one example of a workflow 200 for estimating false echoes for use during tank measurements and FIGS. 3 and 4 illustrate specific example implementations of the workflow 200, various changes may be made to FIGS. 2 through 4. For example, additional operations could be included as part of the workflow 200, and the workflow 200 could be implemented in ways other than those shown in FIGS. 3 and 4.

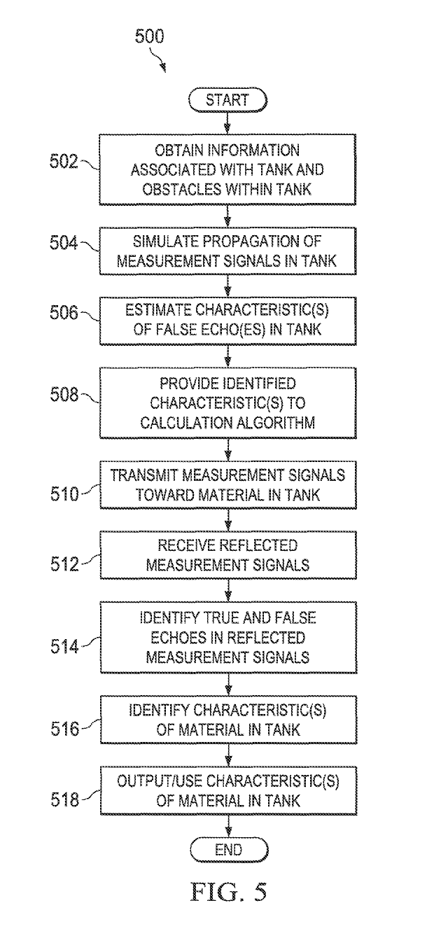

FIG. 5 illustrates an example method 500 for estimating false echoes for use during tank measurements according to this disclosure. For ease of explanation, the method 500 is described with respect to the sensor 106 and processing systems 110, 120 in the system 100 of FIG. 1 using the components of FIG. 2. However, the method 500 could be used with any other suitable device(s) and in any other suitable system(s).

As shown in FIG. 5, information associated with a tank and one or more obstacles within the tank is obtained at step 502. This could include, for example, the user interface 202 or configuration interface 302, 402 obtaining information identifying different characteristics of the tank 102 and one or more obstacles within the tank 102. The user interface 202 or configuration interface 302, 402 could be provided by the processing system 110, the processing system 120, or some other device. In some embodiments, one, some, or all of the following information could be obtained as inputs (such as from a user) during this step:
The size of a tank 102 where a sensor 106 is or will be installed;
The shape of the tank 102 where the sensor 106 is or will be installed;
The composition of the tank 102 where the sensor 106 is or will be installed;
The position of the sensor 106 in or on the tank 102;
The position of each obstacle in the tank 102;
The shape of each obstacle in the tank 102;
The composition of each obstacle in the tank 102;
The dielectric constant of the material stored or to be stored in the tank 102 (such as a liquid or solid material that the tank 102 is being or will be filled with); and
One or more additional characteristics of the material stored or to be stored in the tank 102, such as turbulent surface, grain size (for solid products like powders), angle of repose, or whether foam may be present on the surface.

The propagation of signals within the tank is simulated at step 504, and one or more characteristics of one or more false echoes within the tank are estimated at step 506. This could include, for example, the simulation/prediction module 206 simulating the propagation of light, radar, ultrasound, or other measurement signals within the tank 102. The simulation could be performed in order to identify the position, amplitude, shape, or other characteristic(s) of false echoes within an envelope curve (also called the “echo curve”). As a particular example, the simulation/prediction module 206 could perform the following operations to estimate the behavior of measurement signals in the tank 102. In some embodiments, these calculations can be performed using wave propagation formulas that are adjusted or calibrated based on laboratory experiments conducted for each type of level or other sensor.
1. Calculate the real distance between a reference plane of a sensor 106 and each obstacle in a tank 102 (this can be a simple distance calculation). The reference plane could, as an example, be defined by the transceiver 108, an antenna, or other portion of the sensor 106.
2. Calculate a predicted position of the reflection from each obstacle in the envelope curve as seen by the sensor 106.
3. Calculate a predicted amplitude of the reflection from each obstacle or surface of the material 104. The amplitude could be calculated based on the following equation:

A=A₀×K (1)

where A is the predicted amplitude, A₀ is the initial amplitude of a signal sent by the transceiver 108, K is given as:

$$K = [ 1 - \frac{( 4 \times \sqrt{D C} )}{{( 1 + \sqrt{D C} )}^{2}} ] \times F \qquad ( 2 )$$

DC is the dielectric constant of the reflective surface, and F is a practically-determined factor (such as a laboratory-calculated factor) corresponding to one or more of the material, shape, and size of the reflective surface. Equation (1) above is an example that would be valid for electromagnetic wave propagation in case of guided wave radar measurement systems. These equations would be different for other embodiments, such as ultrasonic or laser systems.
4. Calculate the predicted shape of the reflection from each obstacle (optional). For example, the shape can be described by giving a polynomial and corresponding factors or a base shape and corresponding factors like height and width. These factors can be based on laboratory experiments and can be used with the same meaning by the simulation/prediction module 206 and the calculation algorithm 210.

The one or more identified characteristics of the one or more false echoes are provided or otherwise made available to a calculation algorithm at step 508. This could include, for example, the simulation/prediction module 206 outputting to the calculation algorithm 210 a set of data representing the following parameters for each obstacle or tank surface:
The predicted position of a reflection from that obstacle or tank surface in an envelope curve;
The predicted amplitude of the reflection from that obstacle or tank surface;

and
The predicted shape of the reflection from that obstacle or tank surface (optional).

The information about the false echoes can be used by the calculation algorithm during tank measurements. For example, measurement signals are transmitted toward a material in a tank at step 510, and reflected measurement signals are received at step 512. This could include, for example, generating and transmitting light, radar, ultrasound, or other measurement signals using the transceiver 108 and receiving both true and false echo reflections at the transceiver 108. The true and false echoes in the reflected measurement signals are identified at step 514. This could include, for example, the calculation algorithm 210 using the information 208 about the false echoes from the simulation/prediction module 206 to identify and reject false echoes in the return measurement signals. This makes it much easier for the calculation algorithm 210 to identify and track the true reflection of the measurement signals from the material 104 in the tank 102. The calculation algorithm 210 could be performed by the sensor 106, the processing system 110, or some other device.

The level or other characteristic(s) of material in the tank is identified at step 516. This could include, for example, the calculation algorithm 210 performing time of flight calculations or other calculations using the true echoes of the measurement signals from the surface of the material 104. The level or other characteristic(s) of material is output or used in some manner at step 518. This could include, for example, the sensor 106 or the processing system 110 displaying the measurement locally at the sensor 106 or remotely, such as on the display 116 or user device 118. This could also include the sensor 106 or the processing system 110 using the measurement to control the pump 112 or providing the measurement to the controller 114 for use in controlling the pump 112. The measurement could be used in any other or additional manner.

Although FIG. 5 illustrates one example of a method 500 for tank measurement, various changes may be made to FIG. 5. For example, while shown as a series of steps, various steps in FIG. 5 could overlap, occur in parallel, occur in a different order, or occur any number of times. As noted above, for instance, the estimation of false echoes could occur during actual measurements.

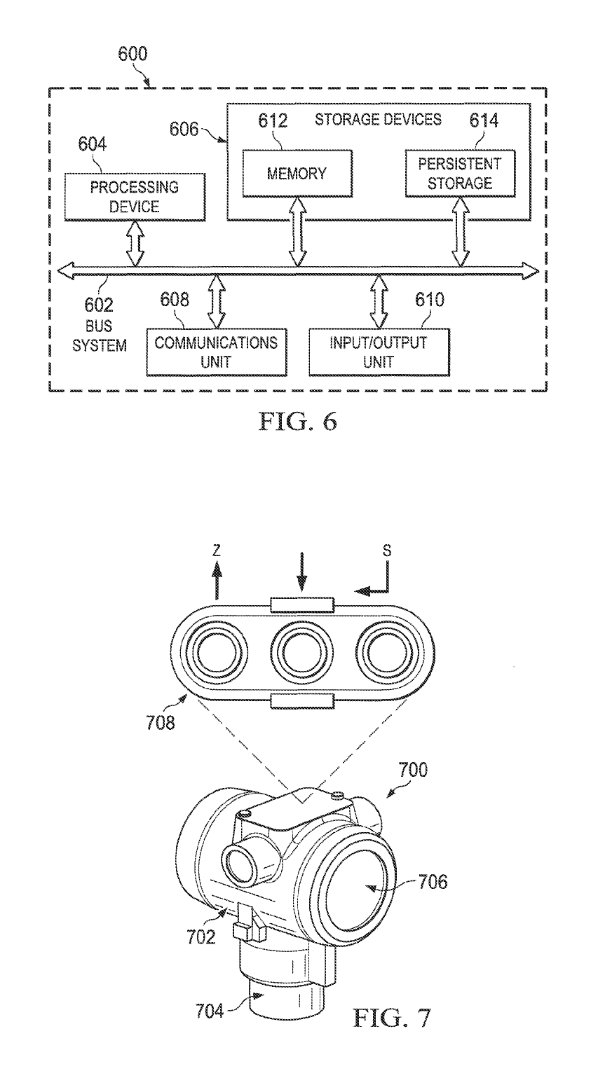

FIG. 6 illustrates an example processing system 600 for tank measurements according to this disclosure. The processing system 600 could, for example, represent the processing system 110 and/or the processing system 120 of FIG. 1. Note, however, that any other suitable processing system could be used in the system 100 of FIG. 1.

As shown in FIG. 6, the processing system 600 includes a bus system 602, which supports communication between at least one processing device 604, at least one storage device 606, at least one communications unit 608, and at least one input/output (I/O) unit 610. The processing device 604 executes instructions that may be loaded into a memory 612. The processing device 604 may include any suitable number(s) and type(s) of processors or other devices in any suitable arrangement. Example types of processing devices 604 include microprocessors, microcontrollers, digital signal processors, field programmable gate arrays, application specific integrated circuits, and discrete circuitry.

The memory 612 and a persistent storage 614 are examples of storage devices 606, which represent any structure(s) capable of storing and facilitating retrieval of information (such as data, program code, and/or other suitable information on a temporary or permanent basis). The memory 612 may represent a random access memory or any other suitable volatile or non-volatile storage device(s). The persistent storage 614 may contain one or more components or devices supporting longer-term storage of data, such as a ready only memory, hard drive, Flash memory, or optical disc.

The communications unit 608 supports communications with other systems or devices. For example, the communications unit 608 could include a network interface that facilitates communications over at least one Ethernet, HART, FOUNDATION FIELDBUS, or other network. The communications unit 608 could also include a wireless transceiver facilitating communications over at least one wireless network. The communications unit 608 may support communications through any suitable physical or wireless communication link(s).

The I/O unit 610 allows for input and output of data. For example, the I/O unit 610 may provide a connection for user input through a keyboard, mouse, keypad, touchscreen, or other suitable input device. The I/O unit 610 may also send output to a display, printer, or other suitable output device.

As described above, the processing system 600 could execute instructions used to perform any of the following functions or any combination of the following functions:
collect or generate target application information associated with a sensor 106, possibly using a graphical user interface such as those described below;
predict false echoes that may be received by the sensor 106 using the simulation/prediction module 206; and
execute the calculation algorithm 210.
   Note that multiple processing systems could also be used to execute different ones of these functions.

Although FIG. 6 illustrates one example of a processing system 600 for tank measurements, various changes may be made to FIG. 6. For example, various components in FIG. 6 could be combined, further subdivided, or omitted and additional components could be added according to particular needs. Also, computing devices can come in a wide variety of configurations, and FIG. 6 does not limit this disclosure to any particular configuration of computing device.

FIG. 7 illustrates a specific example of a tank sensor 700 according to this disclosure. As shown in FIG. 7, the tank sensor 700 includes a housing 702 that can encase, support, or otherwise hold electronic components of the sensor 700, such as electronics used to generate and process signals used during measurements. The housing 702 includes a process connection 704, which allows the sensor 700 to be secured in place to a tank.

The sensor 700 further includes a display 706, which can be used to present various information to a user. For example, the display 706 could present information identifying the operating mode or status of the sensor 700, as well as measurements captured by the sensor 700. In addition, the sensor 700 includes a keypad 708, which in this example includes three buttons. The three buttons here include increment (↑), decrement (↓), and select ( [symbol] ) buttons. However, any other suitable buttons supporting any other suitable functions could be used with the sensor 700.

In some embodiments, the display 706 and the keypad 708 can be used to present information to and collect information from a user. For example, the display 706 could present a version of the user interface 202 to a user, where the user interface 202 includes options for defining one or more characteristics of the tank 102, the sensor 700, or one or more obstacles in the tank 102. The user could select each characteristic, cycle through various options, and choose the most appropriate option using the keypad 206. This information could then be used to generate the application information 204, which is provided to the simulation/prediction module 206.

Alternatively, the display 706 and the keypad 708 could be used to allow a user to navigate to a particular location for retrieving false echo information 208. For example, previously-calculated false echo information 208 could be stored in a networked memory location, and the user could use the display 706 and the keypad 708 to navigate to the networked memory location. Previously-calculated false echo information 208 could also be stored on a memory card or a portable device, and the user could use the display 706 and the keypad 708 to select an option for loading the false echo information 208 from one of those devices. Note, however, that false echo information 208 could be provided to a calculation algorithm 210 in any other suitable manner.

Although FIG. 7 illustrates one specific example of a tank sensor 700, various changes may be made to FIG. 7. For example, any other suitable tank sensor could use false echo information to determine measurements of material in a tank.

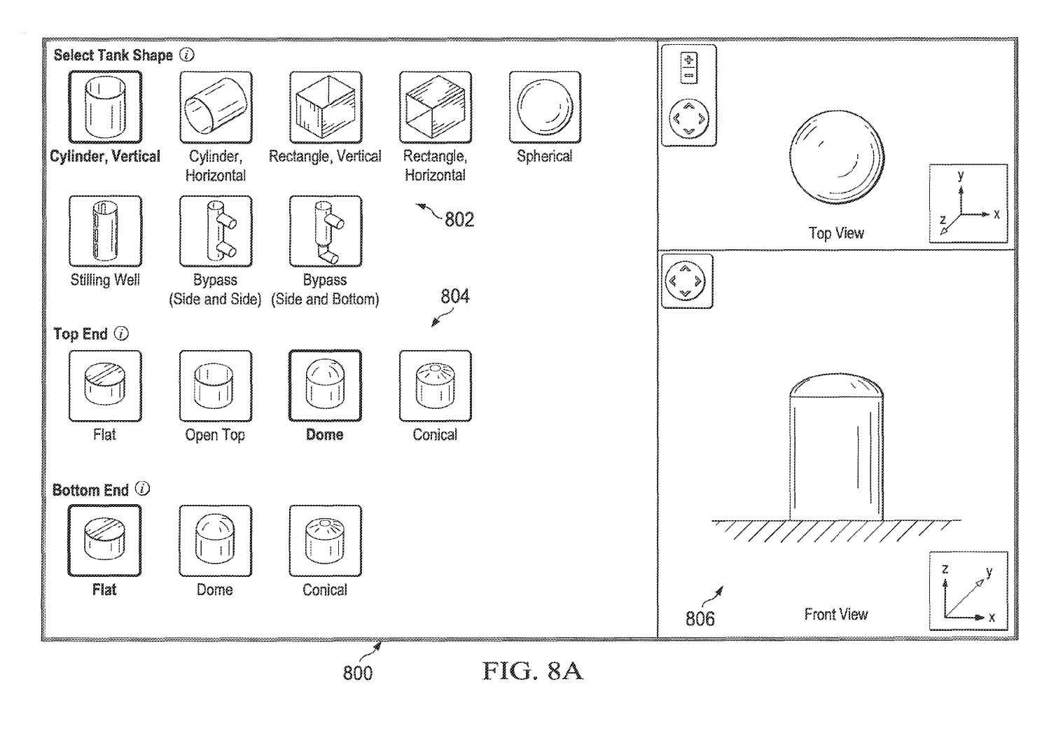

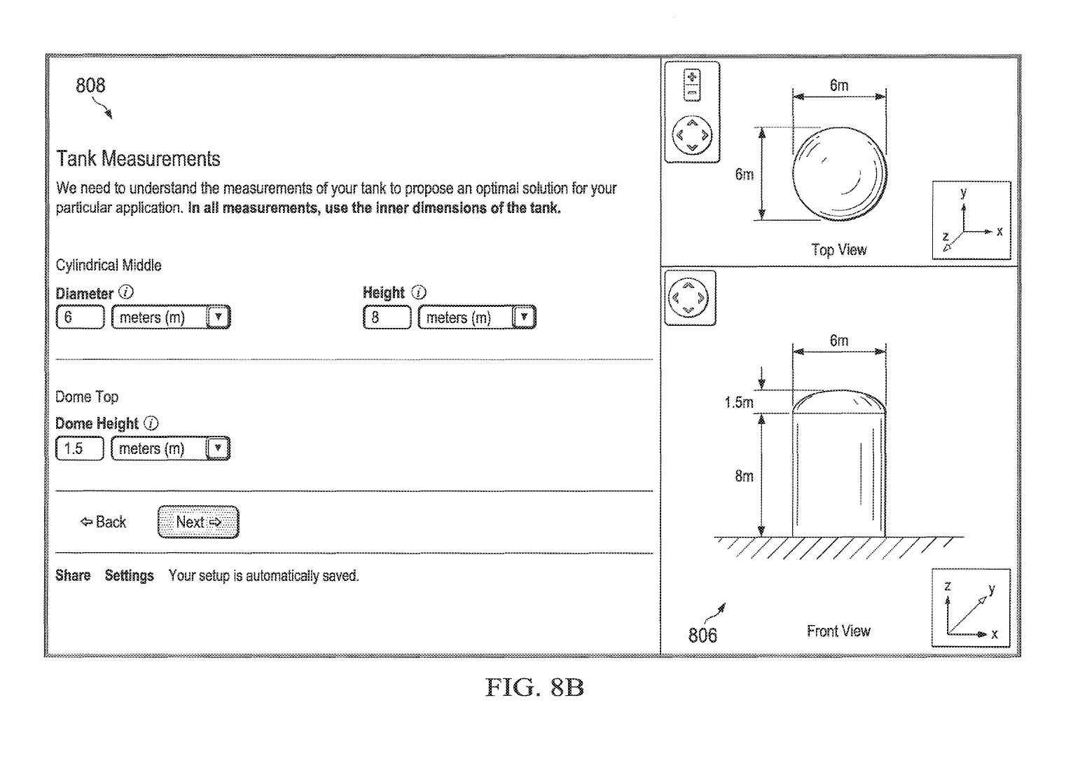

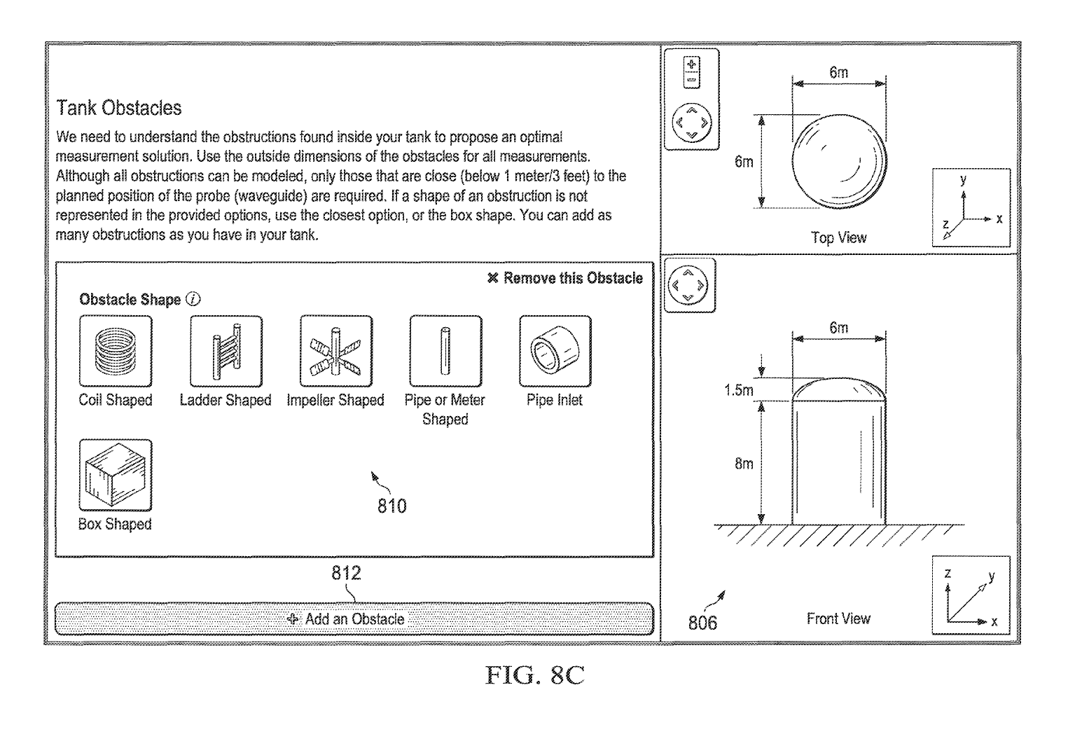

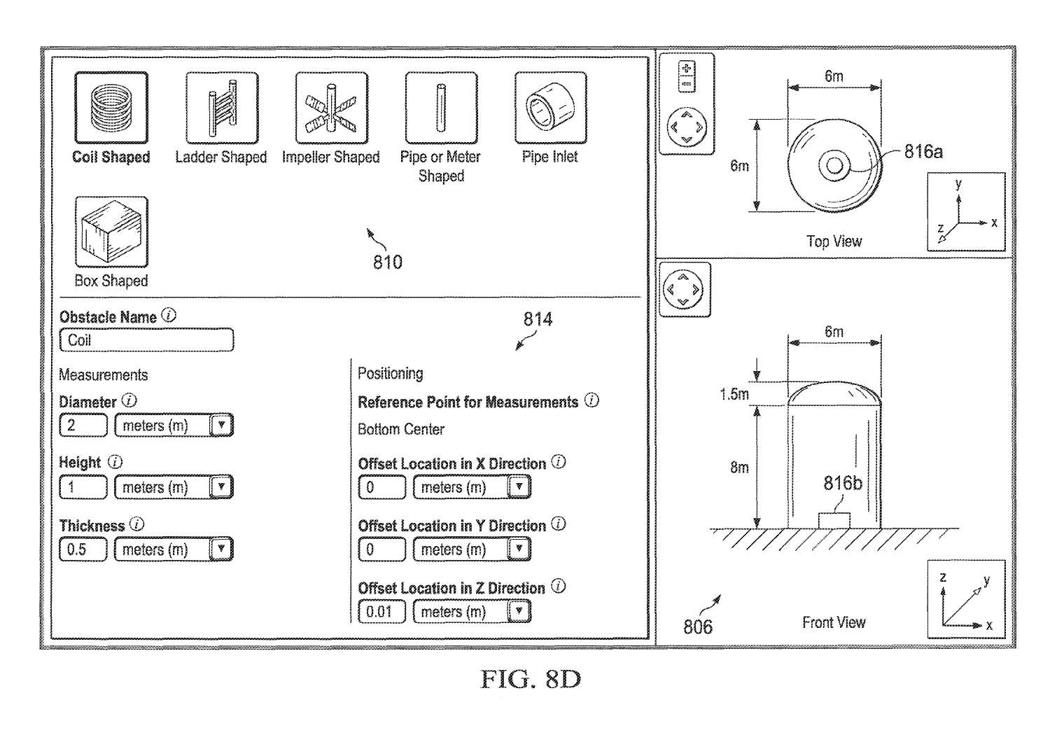

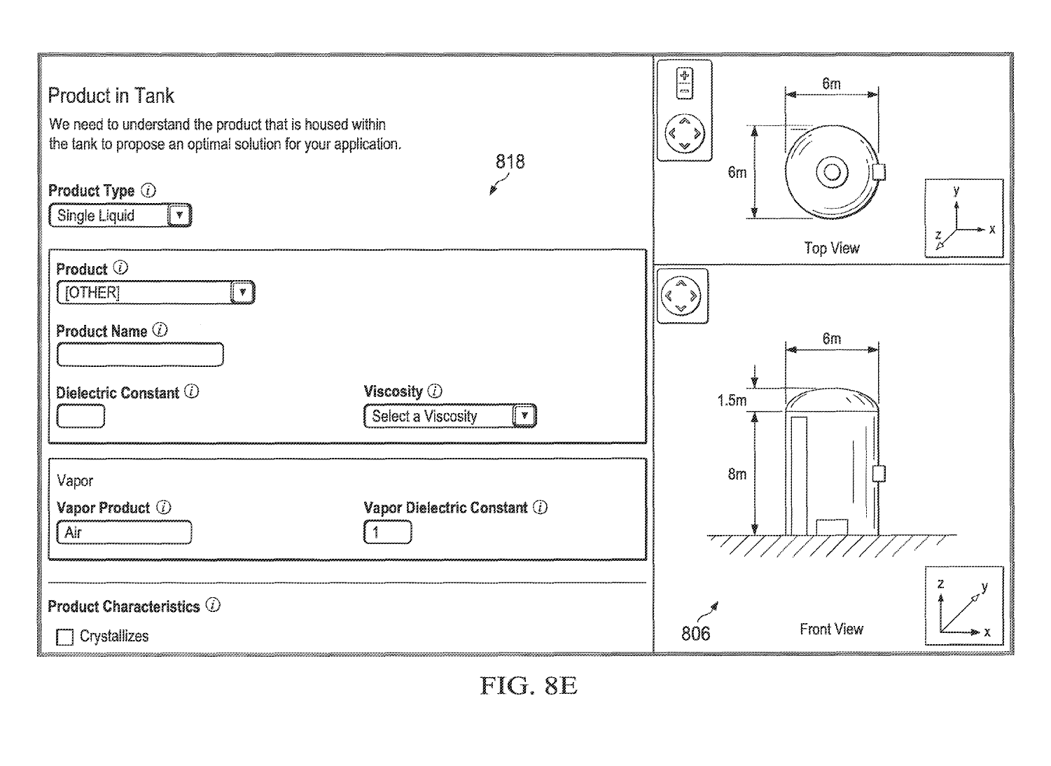

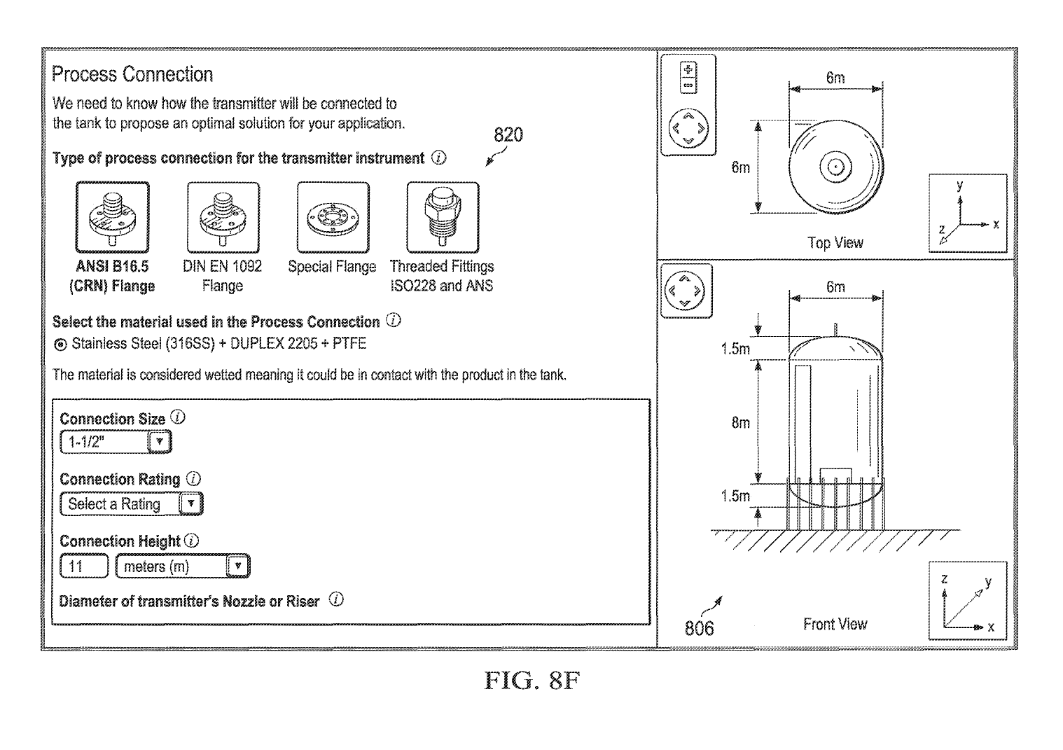

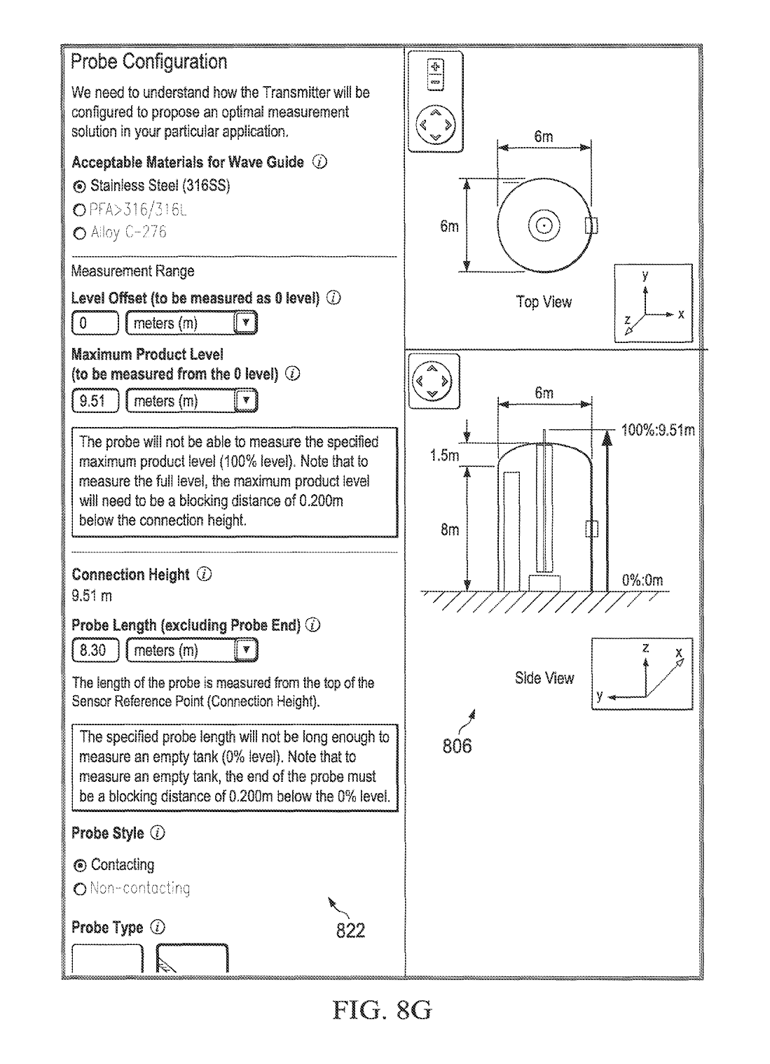

FIGS. 8A through 8G illustrate a first example configuration interface 800 allowing a user to provide information about a target application for a sensor according to this disclosure. The configuration interface 800 could, for example, represent a tool accessible on a computing device or over a network. As a particular example, the configuration interface 800 could be supported by the processing system 120 and be accessible via a web browser.

As shown in FIG. 8A, the configuration interface 800 includes controls 802 allowing a user to define the shape of a tank 102. Here, the controls 802 allow the user to select one of eight different shapes. Additional controls 804 allow the user to define particular characteristics of the tank's shape, where the specific controls 804 presented can vary depending on which shape is selected using the controls 802. Images 806 provide different views of the tank's shape based on the selections made by the user using the controls 802-804.

As shown in FIG. 8B, the configuration interface 800 allows the user to define the dimensions of the tank using controls 808. Again, the dimensions that can be defined using the controls 808 can vary depending on which shape is defined using the controls 802-804. The images 806 can be updated to reflect the provided dimensions of the tank. Although not shown here, the configuration interface 800 could also include a control allowing the user to define the composition of the tank.

As shown in FIG. 8C, the configuration interface 800 allows the user to define one or more obstructions within the tank. Here, controls 810 allow the user to select one of six different types of obstacles for placement within the tank. A control 812 allows the user to create multiple obstacles within the tank. When the user selects one of the obstacle types defined by the controls 810, additional controls 814 as shown in FIG. 8D can be presented to the user. The additional controls 814 allow the user to define a name for an obstacle, dimensions of the obstacle, and placement of the obstacle within the tank. The specific controls 814 presented can vary depending on which type of obstacle is selected by the user using the controls 810. The placement of the obstacle is identified using three values defining the offset of the obstacle from a reference position, although other approaches could be used. The images 806 can be updated with icons 816a-816b identifying each obstacle within the tank. Although not shown, the configuration interface 800 could also include a control allowing the user to define the composition of the obstacle.

As shown in FIG. 8E, the configuration interface 800 allows the user to define the type of material to be stored in the tank using controls 818. The controls 818 allow the user to indicate whether one or multiple materials are or will be stored in the tank. The controls 818 also allow the user to identify the type(s) of material(s) that are or will be stored in the tank, along with characteristics of each material like its dielectric constant and viscosity. The controls 818 further allow the user to identify the vapor product and vapor dielectric constant expected in the tank. In addition, the controls 818 allow the user to define whether each material in the tank has particular characteristics. Example characteristics can include whether the material crystalizes, deposits on or coats structures, has a level rate change above a threshold (such as 40 mm/s), experiences vortex movement, has a turbulent surface, undergoes condensation, or has foam on its surface. Additional controls could also be presented in the configuration interface 800 for obtaining information such as the expected temperature range and pressure range within the tank.

As shown in FIG. 8F, the configuration interface 800 allows the user to define the type of process connection used to couple a sensor to a tank. Controls 820 here allow the user to select one of several types of process connections. The controls 820 also allow the user to define various physical attributes of the selected process connection, such as the material(s) forming the process connection and the size, rating, and height of the process connection. Other attributes can include the diameter and length of the sensor transmitter's nozzle or riser, as well as the sensor connection's radial offset from center. The physical attributes that can be defined by the user can vary depending on the type of process connection selected by the user.

As shown in FIG. 8G, the configuration interface 800 allows the user to define characteristics of the type of probe to be used to make measurements. In this example, controls 822 are provided to define a waveguide probe that is physically inserted into the material in a tank. However, the controls 822 could also be used to define an antenna and other components used to transmit signals wirelessly towards the material in the tank.

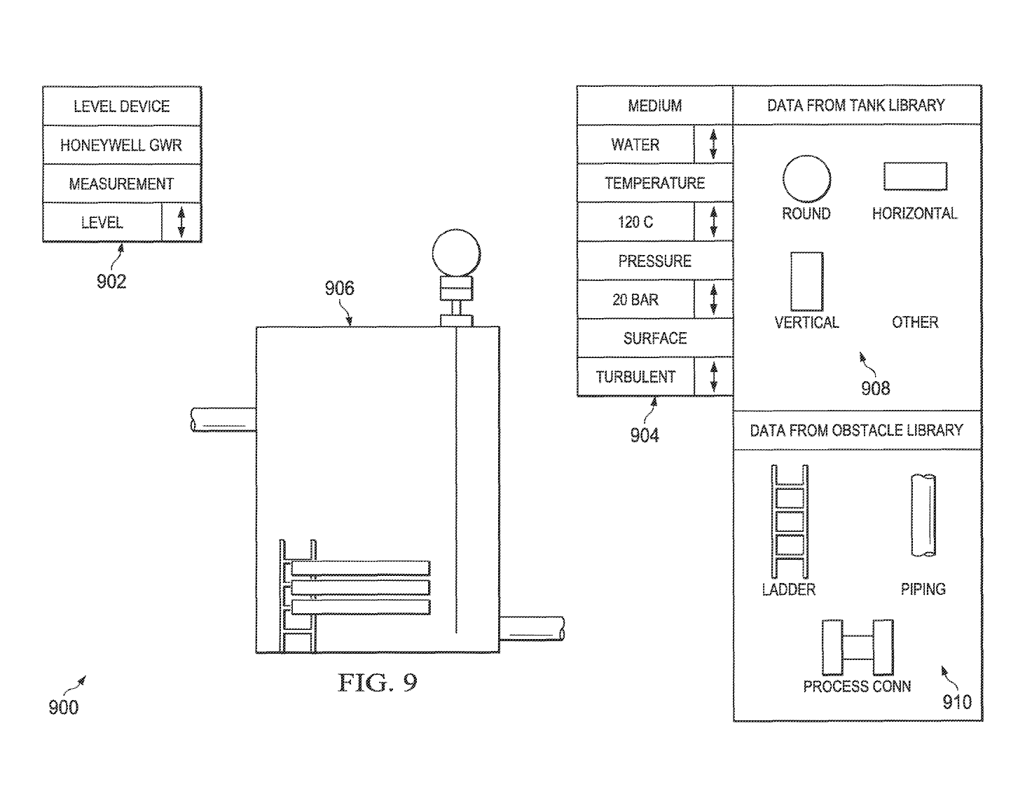

FIG. 9 illustrates a second example configuration interface 900 allowing a user to provide information about a target application for a sensor according to this disclosure. The configuration interface 900 represents a simplified implementation of the user interface for collecting information about a tank and its obstacles. As shown in FIG. 9, the configuration interface 900 includes controls 902 for defining the type of sensor and controls 904 for defining the material to be stored in a tank. The configuration interface 900 also includes an image 906 representing the tank being defined. Controls 908 allow a user to define the shape of the tank, and controls 910 allow the user to define one or more obstacles within the tank. In some embodiments, a “drag and drop” technique allows the user to select a tank shape using the controls 908 and one or more obstacles using the controls 910 for inclusion within the image 906. Obstacles placed within the image 906 could be resized and moved within the image 906, and the size of the tank itself within the image 906 could be adjusted.

The various information collected by the configuration interface 800 or 900 allows the simulation/prediction module 206 to estimate reflections from the tank 102 and obstacles within the tank 102. These estimated reflections are considered false echoes and can be used by a sensor during measurements.

Although FIGS. 8A through 9 illustrate two examples of configuration interfaces allowing a user to provide information about a target application for a sensor, various changes may be made to FIGS. 8A through 9. For example, the various options provided for selection by a user in these configuration interfaces are for illustration only. Any other or additional options could be provided to the user in order to define one or more characteristics of a tank or obstacles within a tank.

In some embodiments, various functions described in this patent document are implemented or supported by a computer program that is formed from computer readable program code and that is embodied in a computer readable medium. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

It may be advantageous to set forth definitions of certain words and phrases used throughout this patent document. The terms “application” and “program” refer to one or more computer programs, software components, sets of instructions, procedures, functions, objects, classes, instances, related data, or a portion thereof adapted for implementation in a suitable computer code (including source code, object code, or executable code). The terms “transmit,” “receive,” and “communicate,” as well as derivatives thereof, encompasses both direct and indirect communication. The terms “include” and “comprise,” as well as derivatives thereof, mean inclusion without limitation. The term “or” is inclusive, meaning and/or. The phrase “associated with,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A method comprising:
obtaining first information defining one or more characteristics of at least one of: (i) a tank configured to store material and (ii) one or more obstacles within the tank;
estimating one or more false echoes using the first information, the one or more false echoes comprising one or more potential reflections of a signal off at least one of: (i) one or more surfaces of the tank and (ii) one or more surfaces of the one or more obstacles; and
providing second information identifying the one or more false echoes to a calculation algorithm configured to measure a characteristic of the material in the tank.

2. The method of claim 1, further comprising:
using the second information at a sensor to identify a true echo of a measurement signal from the material in the tank; and
identifying the characteristic of the material in the tank using the true echo of the measurement signal.

3. The method of claim 1, wherein obtaining the first information comprises:
presenting a user interface to a user; and
receiving, from the user via the user interface, an identification of the one or more characteristics.

4. The method of claim 3, wherein the user interface displays an image of the tank and the one or more obstacles within the tank.

5. The method of claim 3, wherein the one or more characteristics comprise at least one of:
a size, shape, or composition of the tank;
a position of a sensor in or on the tank;
a process connection coupling the sensor to the tank;
a position, shape, or composition of at least one of the one or more obstacles in the tank.

6. The method of claim 1, wherein estimating the one or more false echoes using the first information comprises, for each potential reflection of the signal off one of the surfaces of the tank or the one or more obstacles, identifying at least one of:
an estimated position of the false echo in an envelope curve;
an estimated amplitude of the false echo in the envelope curve; and
an estimated shape of the false echo in the envelope curve.

7. The method of claim 1, wherein estimating the one or more false echoes using the first information comprises, for each potential reflection of the signal off one of the surfaces of the tank or the one or more obstacles:
identifying a distance between a reference position associated with a sensor and that surface; and
identifying at least one of a position, an amplitude, and a shape of a reflection from that surface using the identified distance.

8. The method of claim 1, wherein providing the second information comprises providing data identifying, for each potential reflection of the signal off one of the surfaces of the tank or the one or more obstacles, at least one of:
an estimated position of the false echo from that surface in an envelope curve;
an estimated amplitude of the false echo from that surface in the envelope curve; and
an estimated shape of the false echo from that surface in the envelope curve.

9. An apparatus comprising:
at least one processing device configured to:
obtain first information defining one or more characteristics of at least one of: (i) a tank configured to store material and (ii) one or more obstacles within the tank;
estimate one or more false echoes using the first information, the one or more false echoes comprising one or more potential reflections of a signal off at least one of: (i) one or more surfaces of the tank and (ii) one or more surfaces of the one or more obstacles; and
provide second information identifying the one or more false echoes to a calculation algorithm configured to measure a characteristic of the material in the tank.

10. The apparatus of claim 9, further comprising:
at least one interface configured to provide the second information to a sensor that is configured to perform the calculation algorithm.

11. The apparatus of claim 9, wherein the at least one processing device is further configured to perform the calculation algorithm.

12. The apparatus of claim 9, wherein, in order to obtain the first information, the at least one processing device is configured to:
present a user interface to a user; and
receive, from the user via the user interface, an identification of the one or more characteristics.

13. The apparatus of claim 12, wherein the user interface is configured to display an image of the tank and the one or more obstacles within the tank.

14. The apparatus of claim 9, wherein, in order to estimate the one or more false echoes using the first information, the at least one processing device is configured, for each potential reflection of the signal off one of the surfaces of the tank or the one or more obstacles, to identify at least one of:
an estimated position of the false echo in an envelope curve;
an estimated amplitude of the false echo in the envelope curve; and
an estimated shape of the false echo in the envelope curve.

15. The apparatus of claim 9, wherein, in order to estimate the one or more false echoes using the first information, the at least one processing device is configured, for each potential reflection of the signal off one of the surfaces of the tank or the one or more obstacles, to:
identify a distance between a reference position associated with a sensor and that surface; and
identify at least one of a position, an amplitude, and a shape of a reflection from that surface using the identified distance.

16. A non-transitory computer readable medium containing instructions that when executed cause at least one processing device to:
obtain first information defining one or more characteristics of at least one of:
(i) a tank configured to store material and (ii) one or more obstacles within the tank;
estimate one or more false echoes using the first information, the one or more false echoes comprising one or more potential reflections of a signal off at least one of: (i) one or more surfaces of the tank and (ii) one or more surfaces of the one or more obstacles; and
provide second information identifying the one or more false echoes to a calculation algorithm configured to measure a characteristic of the material in the tank.

17. The non-transitory computer readable medium of claim 16, further containing instructions that when executed cause at least one processing device to at least one of:
provide the second information to a sensor that is configured to perform the calculation algorithm; and
perform the calculation algorithm.

18. The non-transitory computer readable medium of claim 16, wherein the instructions that when executed cause the at least one processing device to estimate the one or more false echoes using the first information comprise instructions that when executed cause the at least one processing device, for each potential reflection of the signal off one of the surfaces of the tank or the one or more obstacles, to identify at least one of:
an estimated position of the false echo in an envelope curve;
an estimated amplitude of the false echo in the envelope curve; and
an estimated shape of the false echo in the envelope curve.

19. The non-transitory computer readable medium of claim 16, wherein the instructions that when executed cause the at least one processing device to estimate the one or more false echoes using the first information comprise instructions that when executed cause the at least one processing device, for each potential reflection of the signal off one of the surfaces of the tank or the one or more obstacles, to:
identify a distance between a reference position associated with a sensor and that surface; and
identify at least one of a position, an amplitude, and a shape of a reflection from that surface using the identified distance.

20. A method comprising:
receiving information identifying one or more false echoes, the one or more false echoes comprising one or more potential reflections of a signal off at least one of (i) a tank configured to store material and (ii) one or more obstacles within the tank;
transmitting a measurement signal towards the material in the tank;
receiving a return signal containing a true echo of the measurement signal off the material in the tank and one or more actual false echoes; and
identifying a characteristic of material in the tank using the true echo of the measurement signal by rejecting the one or more actual false echoes using the information identifying the one or more false echoes.

21. The method of claim 20, wherein the characteristic of the material in the tank comprises at least one of: a level of the material in the tank, a distance of the material in the tank from a reference location, a volume of the material in the tank, and a mass of the material in the tank.
